(19) United States
(12) Patent Application Publication
(10) Pub. No.: US 2003/0014667 A1
(43) Pub. Date: Jan. 16, 2003

(54) Buffer overflow attack detection and suppression

(76) Inventor: Andrei Kolichtchak, Nizhny Novgorod (RU)

Correspondence Address: John W. Ryan, WILMER CUTLER & PICKERING, 2445 M. Street, N.W., Washington, DC, 20037-6000, US

(21) Appl. No.: 09/904,502

(22) Filed: Jul. 16, 2001

(51) Int. Cl. G06F 11/30; G06F 15/173

(52) U.S. Cl. 713/201; 709/223

(57) ABSTRACT

A page fault proxy handler and related method defend against buffer overflow attacks. The page fault proxy handler is for connection to an original page fault handler and a paging table in which supervisor flags for all entries for all writable memory pages have been pre-set. The page fault proxy handler comprises a page fault detector, a page fault filter, an execution address checker, a mitigation module, and a controlled memory access module. The detector detects page faults and passes them to the filter. The filter passes to the original page fault handler page faults not arising from an attempt to access a writable page by a user mode program. The execution address checker passes to the mitigation module only page faults arising from an attempt by a user mode program to execute from the writable page; other accesses to a writable page by a user mode program are passed to the controlled memory access module. The mitigation logs and/or terminates the program. The controlled memory access module permits the user program to access the writable page by changing an associated supervisor flag in the paging table. The method handles page faults in conjunction with an original page fault handler. The method sets a supervisor flag in a page entry table associated with a writable page. The method detects a page fault and determines whether it arises from an attempt by a user mode program to execute from the writable page having the associated supervisor flag set. The method conditionally calls the original page fault handler on the basis of the determining step.

### FIELD OF THE INVENTION

This invention relates generally to computer security and more particularly to software for combatting buffer overflow attacks.

### BACKGROUND OF THE INVENTION

The security of computer systems is a topic of very serious concern to almost every enterprise in today's society. Broadly speaking, there are two aspects of computer security. One aspect concerns the unwanted escape of information from the computer system to the outside world. The threat of unwanted escape of information takes several forms. In one form, hackers may attempt to gain access to an enterprise's computer system so as to pilfer valuable information. In another form, disloyal employees or other “insiders” may attempt to accomplish the same end by the access that they legitimately have. Another aspect of computer security concerns the invasion of unwanted objects, such as viruses, from the outside world into the computer system. Infection of a computer system by a Trojan horse, for example, can disturb or disable the computer system or an application and thereby severely affect productivity.

A particularly troublesome computer security threat is a buffer overflow attack. A buffer overflow attack occurs when a hacker overflows an input buffer on the execution stack with more data than the application is designed to accept. Buffer overflow attacks exploit the lack of bounds checking on the size of input being stored in a buffer. An attack usually comprises three elements: (1) arbitrary strings of sufficient length to overflow the buffer; (2) malicious/exploiting code; and (3) a new return address pointing to the malicious/exploiting code.

Often, the application program is a web server, which provides a convenient point of access for a hacker. As a concrete example, assume that the web server is programmed to prompt a user for a URL (uniform resource locator) and to store the entered characters as a string designated as 100 characters long. When a programmer writes the web server to accept this URL from a user, the programmer should provide code to check that the number of characters does not exceed 100, the maximum storage space allocated for that input. If, due to programmer error, the application does not check the size of input entered, a user could crash the web server by entering more data and thus overflowing an input buffer. Because human mistakes cannot be totally eliminated, these susceptibilities will exist from time to time.

There are hackers who specialize in analyzing popular applications for such programming errors. When they find one, they try to add specially crafted code to the data they send. To continue the same example, a hacker may send to a web server 101 characters followed by code that executes a telnet server (or any other application). This allows the hacker to take full control of the computer hosting the web server.

The frequency of buffer overflow attacks is alarming. According to one estimate, 24% of all United States companies suffered a buffer overflow attack in the year 2000. See Andy Briney, “Security Focused: 2000 Information Security Industry Survey,” Information Security, pages 40-68, September 2000. As this statistic shows, buffer overflow attacks are a serious problem.

It is generally understood that buffer overflow attacks can be suppressed by disabling code execution in writable memory areas. Unfortunately, there is no easy way to make memory areas non-executable with some microprocessors. For example, IA (Intel™ architecture) 32 microprocessors (e.g., Intel™ Pentium™ microprocessors, their successors and compatibles such as those manufactured by AMD™), which are presently the most prevalent microprocessors used in personal computers, do not have special features for marking memory pages as being non-executable. As a result, impeding buffer overflow attacks on these microprocessors is especially challenging—at least doing so without a large performance overhead.

One solution for detecting and suppressing buffer overflow attacks in IA-32 microprocessors without a large performance overhead has been developed by PaX. Their solution is documented at PaX, (untitled) [online] (undated) [retrieved on 2001-03-15], retrieved from the Internet:<URL:http://pageexec.virtualave.net/pageexec.txt>, which is hereby incorporated by reference. Their solution exploits certain features of the paging system in certain processors (e.g., IA-32 processors). The PaX solution can be best understood by considering FIGS. 1 and 2.

FIG. 1 is a block diagram of a computer architecture 100 including a virtual memory 110 utilizing paging. The computer architecture 100 comprises a CPU (central processing unit) core 120, a paging system 130 as well as the virtual memory 110. The CPU core references data and instructions in a linear address space (e.g., from address 00000000h to FFFFFFFFh). However, the virtual memory 110 comprises a smaller RAM (random access memory) 140 or similar physical memory augmented by a disk storage 150 or other memory, which is typically less expensive and slower to access. The paging system 130 translates between the linear (also called logical) address space used by the CPU core 120 and the physical memory addresses in the virtual memory 110. When paging is used, the linear address space is divided into fixed-size pages (e.g., 4 KB (kilobytes),2 MB (megabytes) or 4 MB) that can be mapped into the RAM 140 and/or the disk storage 150. When a program references a logical address in memory, the paging system 130 translates the linear address into a corresponding physical address. If the page containing the linear address is not currently in the RAM 140, the paging system 130 generates a page fault exception (#PF), which is herein referred to more simply as a “page fault.” An exception handler (not shown), provided as part of the operating system, for the page fault typically directs the operating system or executive to load the page from the disk storage 150 into the RAM 140, perhaps writing a different page from the RAM 140 to the disk storage 150 in the process. In other words, the page is “faulted in.” When the page has been faulted into the RAM 140, a return from the exception handler causes the instruction that generated the exception to be restarted. The information that the processor uses to map linear addresses into the physical address space and to generate page faults, when necessary, is contained in a page directory 160 and/or a page table 170.

In the Windows NT™ operating system on an IA-32 microprocessor, the linear address space is 4 GB (gigabytes), and the page size is 4 KB in user mode. In this case, the paging system has a single page directory and 1,024 page tables. The page directory has 1,024 entries, each of which points to one of the page tables. Each page table has 1,024 entries (“page table entries”) and each page table entry (PTE) points to a page in the virtual memory 110. For additional information about paging in IA-32 microprocessors, the reader is referred to “Intel Architecture Software Developer's Manual,” Volume 3: System Programming, 1999, (order no. 243192), §§3.6-3.7, pp. 3-18-3-29.

FIG. 2 illustrates an entry in the page directory 160 or the page table 170. The entry 200 comprises a number of fields, a few of which are of interest presently. An address field ADDR contains a physical address of a page in the virtual memory 110, in the case of a page table entry, or a pointer to the page table 170, in the case of a page directory entry. The entry 200 also contains several flags or attributes of the page or group of pages. These attributes include a present attribute P, a read/write flag R/W; and a user/supervisor flag U/S. The present attribute P indicates whether the page or group of pages in the page table being pointed to by the entry is currently loaded in physical memory. The read/write flag R/W specifies the read-write privileges for a page or group of pages. The user/supervisor flag U/S specifies the user-supervisor privileges for a page or group of pages. This page-level protection mechanism allows restricting access to pages based on these two privilege levels. User mode is the less privileged level. Most applications and user programs operate in user mode, with the supervisor flag cleared. Supervisor mode is the more privileged level. The operating system and kernel mode programs operate in the supervisor mode, using memory pages having the supervisor flag set. When the processor is in supervisor mode, it can access all pages; when in user mode, it can access only user-level pages. When the processor tries to access a page having its supervisor flag set, a page fault occurs.

To minimize the time required for address translation, the most recently accessed page table entries are cached in the processor in structures typically called translation lookaside buffers (TLBs). The TLBs satisfy most requests for reading the current page directory and/or page tables without requiring an additional bus cycle, and paging is most often performed using the contents of the TLBs. Bus cycles to access the page directories and page tables are incurred only when the TLBs do not contain the translation information for a requested page. Returning to FIG. 1, there is one TLB for data—the data TLB (DTLB) 180—and another for instructions—the instruction TLB (ITLB) 190.

Because the TLBs are caches, a number of the attribute fields in the entry 200 (FIG. 2) relate to cache management. More specifically, the entry 200 includes a dirty flag D, and an accessed flag A.

In normal operation, if the same page table entry is cached in both the DTLB and the ITLB, the entries in both TLBs would be identical. The PaX technique, however, forces the DTLB and ITLB into inconsistent states in such a way that only data read/write accesses are allowed and code execution prohibited. More specifically, for those pages desired to be non-executable, the PaX technique creates PTEs for those pages with the user/supervisor flag U/S set in the supervisor (i.e., “S”) state and generally keeps the PTEs in the S state. The PaX technique next modifies the operating system's page fault handler in two ways. First, when the ITLB is filled, as happens when an instruction is to be executed from a memory page, a page fault is generated, and the modified page fault handler responds by terminating the program that attempted the execution. Second, when the DTLB is filled, as happens when data is to be accessed (i.e., written or read to/from a memory page), a page fault is also generated, and the modified page fault handler responds by flushing both TLBs, changing the user/supervisor flag U/S to the user state (i.e., “U”), accessing the page, and changing the user/supervisor flag U/S back to the S state before resuming operation of the program that attempted the access.

The PaX technique involves directly modifying the source code of the operating system so as to reset common rights at a high level. By being able to alter the source code directly, the PaX solution is able to modify common rights by changing source code constants such as WRITE_ACCESS. In other words, the PaX technique does not directly manipulate PTEs; rather, it manipulates common rights, which in turn affect PTEs.

Though an important contribution, the PaX solution has several shortcomings. First, the PaX solution is implemented only in the Linux operating system, in which source code is freely available. Their approach is not feasible in other operating systems, such as Windows™, where source code is not openly available. Second, the PaX solution, as a global change to the entire operating system, is difficult to optimize. Third, the PaX solution, as a global change to the entire operating system, does not offer options for adjusting parameters of the solution, tuning performance, etc.

### SUMMARY OF THE INVENTION

In one respect, the invention is a page fault proxy handler for connection to an original page fault handler and a paging table in which supervisor flags for all entries for all writable memory pages have been initially set. The page fault proxy handler comprises a page fault detector, a page fault filter, an execution address checker, a mitigation module, and a controlled memory access module. The filter passes, to the original page fault handler, page faults not arising from an attempt to access a writable page by a user mode program. The execution address checker passes, to the mitigation module, only page faults arising from an attempt by a user mode program to execute from a writable page in a predetermined section of executable memory. The execution address checker passes, to the controlled memory access module, all other page faults arising from an attempt by a user mode program to access the predetermined section of executable memory. The controlled memory access module permits the user program to access the writable page by changing an associated supervisor flag in the paging table.

In another respect, the invention is a method for handling page faults, for use with an original page fault handler. The method sets a supervisor flag in a page entry table associated with a writable page. The method detects a page fault and determines whether the page fault arises from an attempt by a user mode program to access a writable page having the associated supervisor flag set. The method conditionally calls the original page fault handler on the basis of the determining step.

In yet another respect, the invention is an apparatus comprising a number of means for performing the steps of the above method.

In yet another respect, the invention is computer readable medium on which is embedded a program that performs the above method.

In comparison to known prior art, certain embodiments of the invention are capable of achieving certain advantages, including some or all of the following: (1) operation is not dependent upon access to and modification of operating system source code; (2) the performance penalty is not unduly excessive; (3) the performance is more easily optimized; and (4) operation can be varied (e.g., by the use of run-time options or parameters). Those skilled in the art will appreciate these and other advantages and benefits of various embodiments of the invention upon reading the following detailed description of a preferred embodiment with reference to the below-listed drawings.

### BRIEF DESCRIPTION OF THE DRAWINGS

FIG. 1 is a block diagram of a computer architecture;

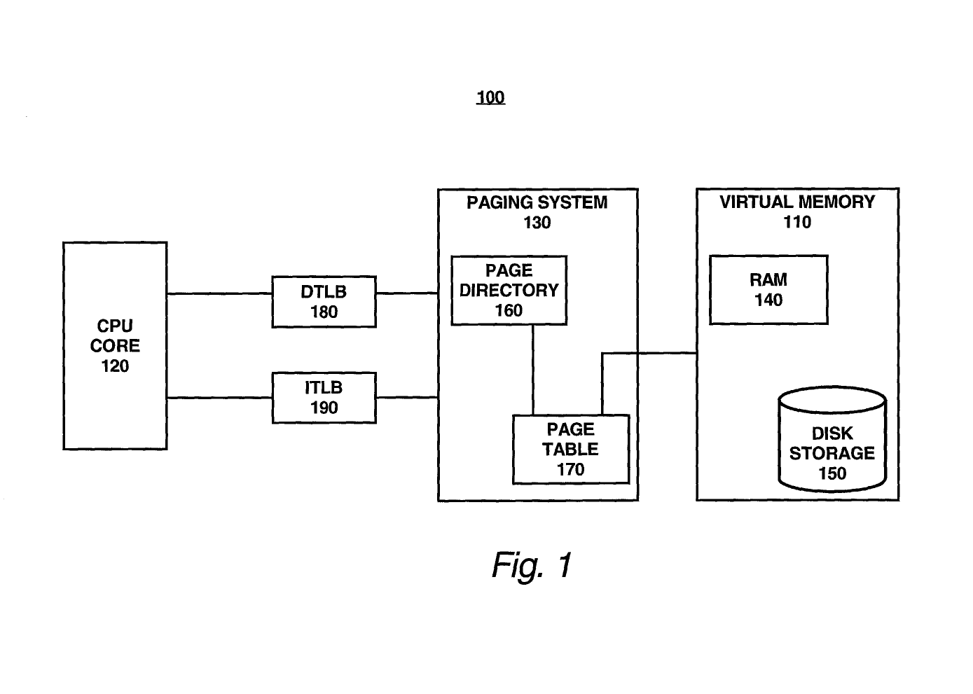

FIG. 2 illustrates a page table entry;

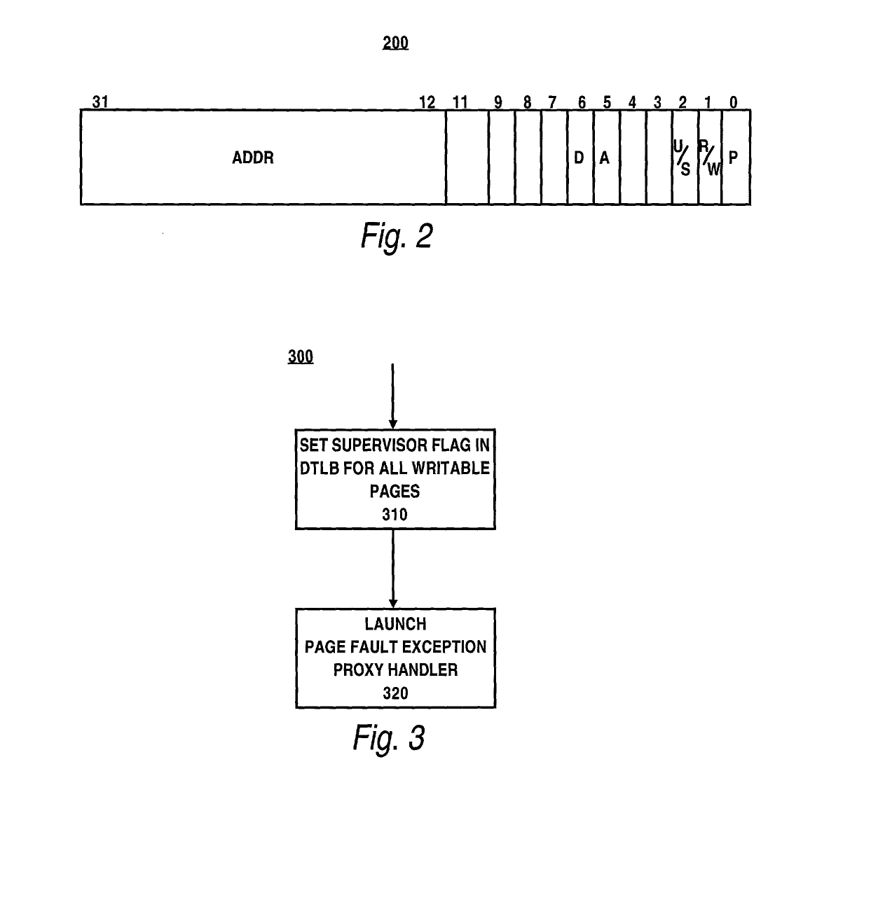

FIG. 3 is a flowchart of a method according to an embodiment of the invention;

FIG. 4 is a flowchart of a method according to an embodiment of the invention; and

FIG. 5 is a block diagram of a software architecture according to an embodiment of the invention.

### DETAILED DESCRIPTION OF A PREFERRED EMBODIMENT

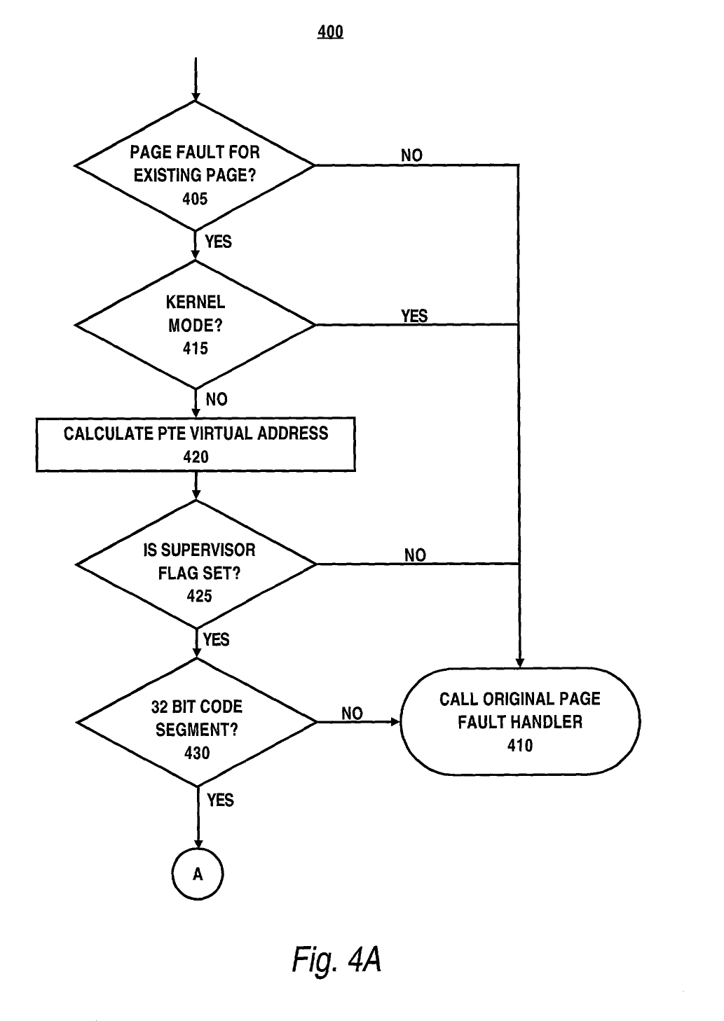

FIG. 3 is a flowchart of a method 300 according to an embodiment of the invention. As a first step, the method 300 sets (310) the supervisor flag (i.e., setting the user/supervisor flag U/S to the “S” state) in the PTEs for all writable pages. Next, the method 300 launches (320) a proxy handler to handle page faults The setting step 310 and the launching step 320 may be performed in the opposite order. As a result of the setting step 310, any subsequent attempt by a user mode program to access a writable page will cause a page fault, which are specially handled by the proxy handler launched by the launching step 320.

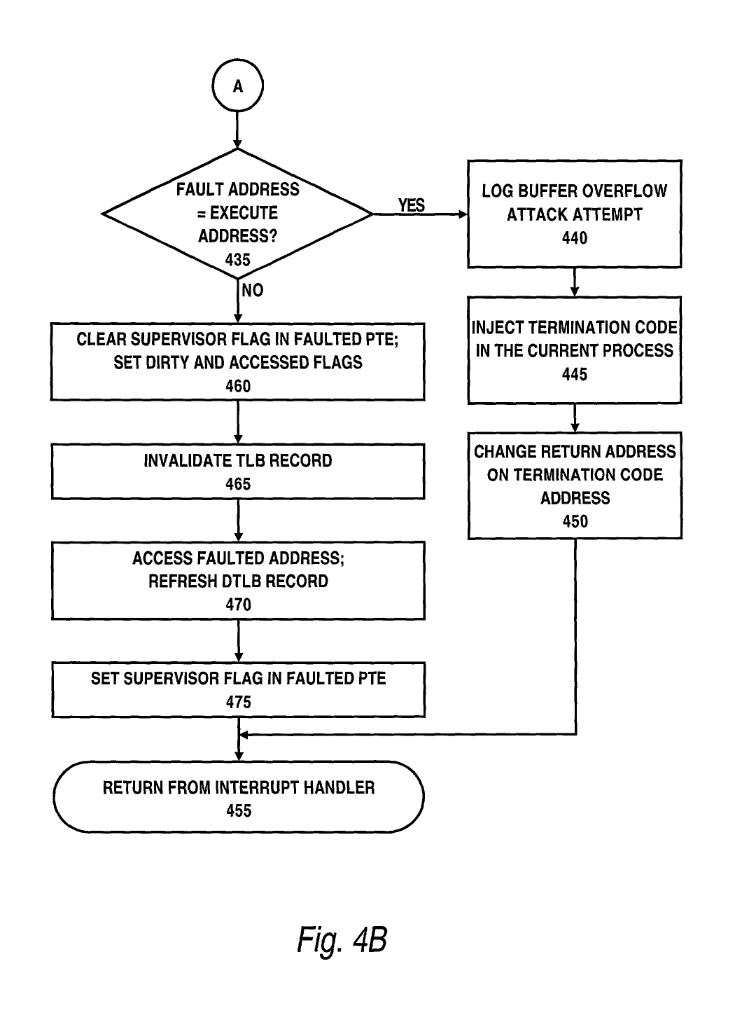

According to an embodiment of the invention, the page fault proxy handler performs a method 400, which is illustrated in FIG. 4. Broadly speaking, the method 400 detects and possibly suppresses user mode programs that attempt to execute from a writable page. The method 400 detects and interrupts these exceptions and takes alerting and/or avoidance measures when the exception would involve execution from writable memory. For other accesses to a writable page, the method 400 temporarily clears the supervisor flag (i.e., sets the user/supervisor flag U/S to the “U” state) in the associated page table entry in the DTLB for that page, just to allow that access to the page.

The method 400 will next be described more specifically with reference to FIG. 4. The method 400 is performed in response to a page fault. First, the method 400 checks (405) whether the page fault is for an existing page. If not, the method 400 calls (410) the original page fault handler, which will load the new page; no special or additional handling is required in this case. If the page fault is not due to a new page, the method 400 checks (415) whether the process is in the kernel (i.e., supervisor) mode. In some embodiments, this can be done by checking the CPL (current processor label) value for the process, which has the value “3” if user mode or the value “0” if kernel mode. A kernel mode process is not of interest, because the method 400 checks only for user mode page faults, and the original page fault handler is called (410) to handle this exception. If the process is in the user mode, the method 400 may calculate (420) a PTE virtual address. In some microprocessors, such as IA-32 microprocessors, the virtual address is an intermediary between the logical address used by the microprocessor core and the physical address in the virtual memory 110. The physical address of a page may change from time to time as the page is moved between the RAM 140 and the disk storage 150. Next, the method 400 checks (425) whether the supervisor flag is set in the PTE. If not, the method 400 calls (410) the original page fault handler. Otherwise, the method continues by checking (430) whether the user program code segment is a 32-bit code segment. In some microprocessors, such as IA-32 microprocessors, smaller code segments, such as 16-bit code segments, can be emulated for backward compatibility. The method 400 preferably ignores these cases of emulation and simply calls (410) the original fault handler.

Although the checking steps 405, 415, 420, 425 and 435 are illustrated in FIG. 4 in a particular order, other embodiments of the invention may perform these steps in a different order, as those skilled in the art would appreciate. Likewise, the virtual address calculation step 420 may be performed earlier or later, relative to the other steps of the method 400, without departing from the invention.

If, at this point in the method 400, the page fault is for an existing page whose PTE supervisor flag is set and the page fault is arising from a user mode 32-bit process, then the method 400 compares (435) the fault address to the current execution address. The fault address is the address in the virtual memory 110 to be accessed when the fault occurred. The current execution address is the contents of the instruction pointer in the CPU core 120.

If the fault address is the execution address, the process is most likely malicious code, and the method 400 logs (440) and/or terminates the program creating that code. In some embodiments, only the logging step 440 is performed, and the method 400 returns (455) immediately after the logging step 440. In other embodiments, the attempted buffer overflow attack is both logged (440) and terminated. More specifically, the termination process may involve injecting (445) termination code in the current process and changing (450) the return address. In still other embodiments, the method 400 may skip the logging step 440 and simply terminate the process without logging. Optionally, the termination process may involve prompting a human operator whether to proceed with the termination.

If the fault address is not the execution address, then the method 400 allows the access to the page under carefully controlled circumstances. More specifically, the method 400 clears (460) the supervisor flag in the associated PTE. Preferably, the method 400 also sets the dirty flag D and the accessed flag A during the clearing step 460. The method 400 then invalidates (465) the TLB record and accesses (470) the faulted address in the virtual memory 110, while refreshing the DTLB record. In some embodiments, the TLB record can be invalidated by a special processor instruction. Preferably soon after the accessing step 470, the method 400 sets the supervisor flag in the faulted page table entry, to inhibit further user mode access (except as performed by the method 400 itself). Finally, the method 400 returns (455).

In an alternative embodiment, the comparing step 435 may additionally check whether the fault address is in a subsection of the total memory 110. To generalize, the comparing step 435 applies only to fault addresses is in a predetermined section of memory, whether that section is all memory or a subsection of the memory. One particular subsection of special interest is the stack. An advantage of checking only the stack is a decreased performance penalty. The steps 460-475 incur a performance penalty on every user mode access to a writable page. By performing the steps 460-475 only in cases where the page is on the stack, performance is impacted less. A disadvantage of checking only the stack is decreased security. It is then possible for malicious code in non-stack executable memory to succeed. However, most buffer overflow attacks occur on the stack, so this is a desirable security-performance tradeoff in most cases.

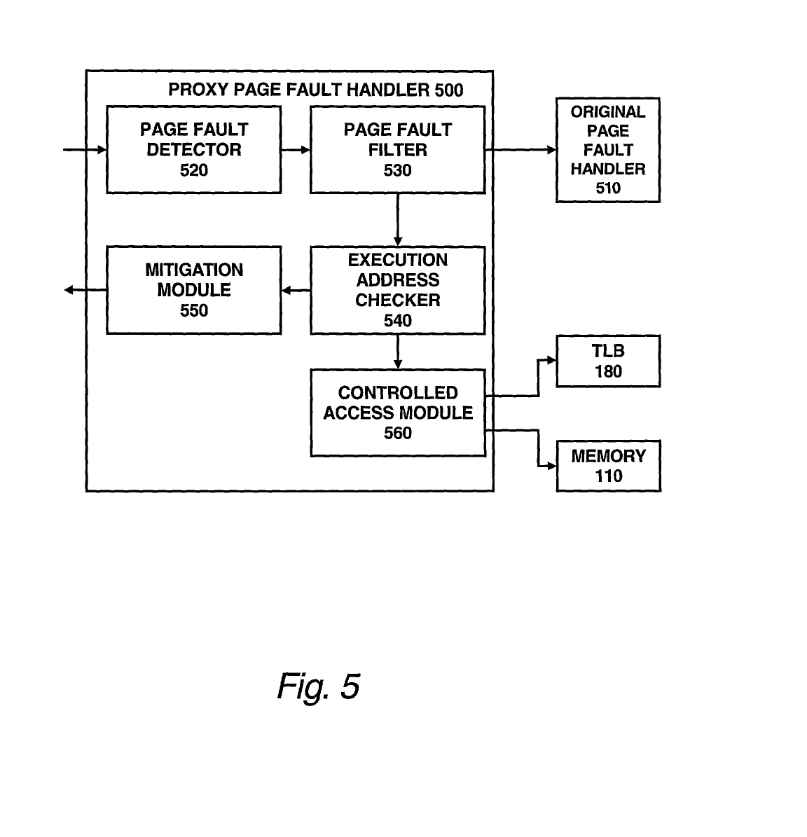

FIG. 5 is a block diagram of a software architecture of a proxy page fault handler 500, according to an embodiment of the invention. The proxy page fault handler 500 interfaces with an original page fault handler 510 supplied by the operating system, the DTLB 180 and the virtual memory 110. The proxy page fault handler 500 comprises a number of modules, including a page fault detector 520, a page fault filter 530, a execution address checker 540, a mitigation module 550 and a controlled access module 560. The structure of the modules 520-560 is preferably software modules (e.g., functions, subprograms, routines, threads, or tasks) running on a general purpose computer. Those skilled in the art would appreciate that equivalent structures are also possible.

The proxy page fault handler 500 preferably performs the method 400 (FIG. 4) or some variation of the same. The page fault detector 520 detects and/or receives page faults as they are generated and forwards them to the page fault filter 530. The page fault filter 530 performs the steps 405, 415, 425 and 430 of the method 400, forwarding to the original page fault handler 510 those page faults not of interest. The page fault filter 530 forwards those page faults that might be due to a buffer overflow attack to the execution address checker 540. The execution address checker 540 performs the step 435 of the method 400, determining whether the fault address is an execute address in a predetermined executable area of memory. If so, the execution address checker 540 calls the mitigation module 550, which performs some or all of the steps 440-455 of the method 400, logging and/or killing the program. That is, the mitigation module 560 may comprise a logging module and/or a code termination module. If the execution address checker 540 determines that the return address is not in an executable area of memory, the control passes to the controlled access module 560, which temporarily toggles a U/S bit in the DTLB 180 and accesses the virtual memory 110.

The proxy page fault handler 500 and the method 400 that it performs preferably do not impose an undue performance overhead. The controlled data access steps 460-475 incur some performance penalty due to extra TLB and PTE manipulations. Code optimization techniques, well-known to those in the art, can minimize this performance penalty for some microprocessors. The overall performance overhead has been measured by experimentation to be typically less than 5% on an IA-32 microprocessor under the Windows NT™ operating system when all memory is protected (i.e., not just the stack or some other subset of memory). With other microprocessors and/or other operating systems, the performance overhead may be more or less. If the performance overhead is more, even considerably more, the proxy page fault handler 500 and the method 400 may still be worthwhile due to the additional security they provide.

The operation of the proxy page fault handler 500 and the method 400 can preferably be varied, and the variations can further influence the performance overhead and other qualities. According to one embodiment, the proxy page fault handler 500 can be launched with several run-time parameters set to desired options. One such parameter is which predetermined area of executable memory is protected. One option in this regard is all writable memory. Another option is just the stack—often a desirable option, because most buffer overflow attacks occur on the execution stack. Yet another option is any other subset of memory, such as the heap.

A second parameter might involve the type of action taken when malicious code is detected. As already explained above, options in this regard include logging the attack only and/or terminating the program and/or prompting an operator for human intervention, such as approval of the termination.

Other parameters and options can tune performance by affecting wrongful detections, which is a legitimate attempt to execute a program from writable memory. Legitimate examples that might be wrongfully detected are self-modifying code and so called “trampolines.” The method 400 can be modified to test for these cases. One test involves checking high-level memory attributes provided by the operating system. These attributes may mark memory blocks as read, write, execute or reserved, for example. Such markings by the operating system overlay the low level paging system. By checking high-level memory attributes, the method 400 can permit execution from memory so designated by the operating system. Another test involves checking for specific code signatures. For the method 400 can check whether the process at issue has a code signature corresponding to programs or routines that are known to use legitimate trampolines. Code signature analysis, per se, is well known to those of ordinary skill in the art.

Another parameter for tuning to decrease false detections is whether services and/or user applications are protected. A user mode program may be launched by a user, in which case it is a “user application” associated with the user's logon or ID (identification). Alternatively, a user mode program may be started before any user's logon, in which case it is termed a “service.” The method 400 can be modified to test for this distinction by examining whether a user ID/logon is associated with the user mode program. Limiting protection to services only is one way to decrease false detections while compromising security only marginally.

The method 400 illustrated in FIG. 4 and the proxy page fault handler 500 can exist in a variety of forms both active and inactive. For example, they can exist as software program(s) comprised of program instructions in source code, object code, executable code or other formats. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), flash memory and magnetic or optical disks or tapes. Exemplary computer readable signals, whether modulated using a carrier or not, are signals that a computer system hosting or running a computer program can be configured to access, including signals downloaded through the Internet or other networks. Concrete examples of the foregoing include distribution of software on a CD ROM or via Internet download. In a sense, the Internet itself, as an abstract entity, is a computer readable medium. The same is true of computer networks in general.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A page fault proxy handler for connection to an original page fault handler and a paging table in which supervisor flags for all entries for all writable memory pages have been pre-set, the page fault proxy handler comprising:
a page fault detector;
a mitigation module;
a page fault filter, connected to the page fault detector, wherein the filter passes to the original page fault handler page faults not arising from an attempt to access a writable page by a user mode program;
a controlled memory access module, wherein the controlled memory access module permits a user program to access a writable page of memory by changing an associated supervisor flag in the paging table; and
an execution address checker, connected to the page fault filter, the mitigation module and the controlled memory access module, wherein the execution address checker passes to the mitigation module only page faults arising from an attempt by a user mode program to execute from a predetermined section of executable memory, and wherein the execution address checker passes to the controlled memory access module page faults arising from any other attempt by a user mode program to access a writable page.

2. The page fault proxy handler of claim 1 wherein the paging cache is a data translation lookaside buffer.

3. The page fault proxy handler of claim 1 wherein the predetermined section of executable memory is a stack.

4. The page fault proxy handler of claim 1 wherein the predetermined section of executable memory is all executable memory.

5. The page fault proxy handler of claim 1 wherein the mitigation module comprises a code termination module.

6. The page fault proxy handler of claim 1 wherein the mitigation module comprises a logging module.

7. The page fault proxy handler of claim 1 wherein the apparatus is for use with an IA-32 microprocessor.

8. A method for handling page faults, for use with an original page fault handler, the method comprising:
setting a supervisor flag in a page entry table associated with a writable page;
detecting a page fault;
determining whether the page fault arises from an attempt by a user mode program to access the writable page having the associated supervisor flag set; and
conditionally calling the original page fault handler on the basis of the determining step.

9. The method of claim 8 further comprising:
providing a page fault proxy handler that performs the detecting determining and conditionally calling steps.

10. The method of claim 9 further comprising:
launching the page fault proxy handler with one or more runtime options.

11. The method of claim 10 wherein the runtime options affect the performance overhead and/or security efficacy of the page fault proxy handler.

12. The method of claim 8, further comprising:
determining whether the page fault was caused by an attempt to execute from the page.

13. The method of claim 12 wherein the page fault is associated with a fault address, and wherein the step of determining whether the page fault was caused by an attempt to execute from the page comprises comparing the fault address to the contents of an instruction pointer.

14. The method of claim 12 further comprising:
if the page fault was not caused by an attempt to execute from the page, then performing at least the following steps:
clearing the supervisor flag in a paging cache associated with the page;
accessing the page after the clearing step; and
setting the supervisor flag after the accessing step.

15. The method of claim 14 wherein the paging cache is a data translation lookaside buffer.

16. The method of claim 12 further comprising:
terminating the user mode program, if the page fault was caused by an attempt to execute from the page.

17. The method of claim 16 wherein the terminating step comprises:
injecting termination code in the user mode program; and
changing a return address.

18. The method of claim 16 wherein the terminating step comprises:
prompting an operator whether to terminate the user mode program; and
accepting a response from the operator.

19. The method of claim 16 wherein the terminating step comprises:
logging an event, if a fault address equals a current execution address.

20. The method of claim 8 further comprising:
determining whether the page fault arises in a predetermined section of memory.

21. The method of claim 20 wherein the predetermined section of memory is all memory.

22. The method of claim 20 wherein the predetermined section of memory is a stack.

23. The method of claim 8 further comprising:
checking whether the page fault is for an existing page of memory.

24. The method of claim 8 further comprising:
checking whether the page fault is for a kernel page of memory.

25. The method of claim 8 wherein the method is performed with an IA-32 microprocessor.

26. An apparatus for use with an original page fault handler, the apparatus comprising:
a means for setting a supervisor flag in a page table associated with a writable page;
a means for detecting a page fault;
a means for determining whether the page fault arises from an attempt by a user mode program to access the writable page having the associated supervisor flag set; and
a means for conditionally calling the original page fault handler on the basis of the determining step.

27. A computer readable medium on which is embedded computer software, the software performing a method for handling page faults, for use with an original page fault handler, the method comprising:
setting a supervisor flag in a page entry table associated with a writable page;
detecting a page fault;
determining whether the page fault arises from an attempt by a user mode program to access the writable page having the associated supervisor flag set; and
conditionally calling the original page fault handler on the basis of the determining step.
